(19) United States
(12) Patent Application Publication
(10) Pub. No.: US 2017/0039579 A1
(43) Pub. Date: Feb. 9, 2017

(54) SENSORY STIMULATION CONTROLS FOR RETAIL ENVIRONMENT

(71) Applicant: Wal-Mart Stores, Inc., Bentonville, AR (US)

(72) Inventor: John Paul Thompson, Bentonville, AR (US)

(21) Appl. No.: 15/213,664

(22) Filed: Jul. 19, 2016

Related U.S. Application Data
(60) Provisional application No. 62/200,808, filed on Aug. 4, 2015.

(51) Int. Cl. G06Q 30/02

(52) U.S. Cl. CPC G06Q 30/0201; G06Q 30/06

(57) ABSTRACT

A sensory system comprises at least one input sensor proximal an item for sale at a retail establishment. The sensor collecting data is related to the item for sale and generating a sensor signal. An analytic engine performs analytics and generates an analytic signal. A sensory processor generates an output device modification signal that is modified in response to the analytic signal and the sensor signal. An output device generates the sensory output according to the output device modification signal.

### RELATED APPLICATIONS

This application claims priority to U.S. Provisional Patent Application Ser. No. 62/200,808, filed on Aug. 4, 2015 entitled “SENSORY STIMULATION CONTROLS FOR RETAIL ENVIRONMENT,” the entirety of which is incorporated by reference herein.

### FIELD

The present concepts relate generally to sensory systems and methods for a retail environment, and more specifically to the triggering of event controls at a retail store used to enhance a customer experience at the store.

### BACKGROUND

A retail sales floor environment can be dynamic in that product positioning changes may often occur in order to improve a customer experience, and increase the likelihood of item purchases by the customer. To achieve this, stores desiring to increase revenues may wish to gather information about sensory information triggering customer behavior regarding a product, and to use this information to modify sensory outputs, such as light, video, sound, smell, and/or position, which may affect customer behavior with respect to items of interest near those sensory outputs.

### BRIEF SUMMARY

In one aspect, a sensory system, comprises at least one input sensor proximal an item for sale at a retail establishment. The sensor collecting data is related to the item for sale and generating a sensor signal. An analytic engine performs analytics and generates an analytic signal. A sensory processor generates an output device modification signal that is modified in response to the analytic signal and the sensor signal. An output device generates the sensory output according to the output device modification signal.

In some embodiments, the at least one input sensor includes a first input sensor and a second input sensor that collectively measure customer interaction.

In some embodiments, the data related to the item for sale includes shopping behavior information.

In some embodiments, the at least one input sensor includes sonar, light sensors, olfactory sensor, color sensor, or motion sensor.

In some embodiments, the sensory processor matches the input sensor data with actions it should take with respect to the output device.

In some embodiments, the sensory system further comprises a device that determines a strategy that is implemented based on the characteristic of the output device.

In some embodiments, the sensory system further comprises a connector between the analytic engine and the sensory processor for providing feedback.

In some embodiments, the feedback includes rate of sale, inventory level, promotional indicator, or customer or social responses.

In some embodiments, the analytics involves combining inputs, and setting outputs correlated with a feedback signal to be optimized.

In another aspect, method for dynamic multi-sensory environmental control comprises collecting data related to an item for sale; generating a sensor signal from the collected data; performing analytics and generating an analytic signal; generating an output device modification signal that is modified in response to the analytic signal and the sensor signal; and outputting the sensory output according to the output device modification signal.

In some embodiments, the method further comprises determining a strategy that is implemented based on the characteristic of the output device.

In some embodiments, the method further comprises providing a connector between the output device and the sensory processor for providing feedback.

In some embodiments, the analytics involves combining inputs, and setting outputs correlated with a feedback signal to be optimized.

In some embodiments, the sensor signal is generated by at least one of sonar, light sensors, olfactory sensor, color sensor, or motion sensor.

In another aspect, a method for setting a sensory output comprises determining sensory data regarding a store item of interest and events occurring near the item; performing analytics to determine an effectiveness of a sensory output of an output device; and adjusting the sensory output of the output device in response to performing the analytics.

In some embodiments, the sensor data is generated by a combination of sonar, a light sensor, an olfactory sensor, a color sensor, and a motion sensor.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a sensory system, in accordance with some embodiments.

FIG. 2 is a data flow diagram illustrating data exchanges with elements of a sensory system, in accordance with some embodiments.

FIG. 3 illustrates an example of a retail environment, in accordance with some embodiments.

FIG. 4 is a flow diagram of a method for setting a sensory output, in accordance with some embodiments.

### DETAILED DESCRIPTION

In the following description, specific details are set forth although it should be appreciated by one of ordinary skill in the art that the systems and methods can be practiced without at least some of the details. In some instances, known features or processes are not described in detail so as to not obscure the present invention.

In brief overview, provided is a system and method that motivates store customers to purchase products in a retail environment. The system and method includes multi-sensory simulation controls using multiple sensors positioned near product areas to measure and respond to customer interaction, and combines the sensor inputs with an analytic engine to modulate the characteristics of various output devices, such as programmable LEDs, sound or olfactory devices, video devices displaying specific content, and so on. The system includes a feedback loop mechanism to optimize sensory output devices, for example, sound, light, video, olfactory, position, tactile, and the like based on optimizing sensory output that causes desired customer behavior, for example, improved sales, profits, increased handling of products, and so on. Analytics are applied to sensor data and sales-related data to provide the best sensory output, for example, one or more of light (color), sound, and smell, in order to improve sales or retail foot traffic in a store.

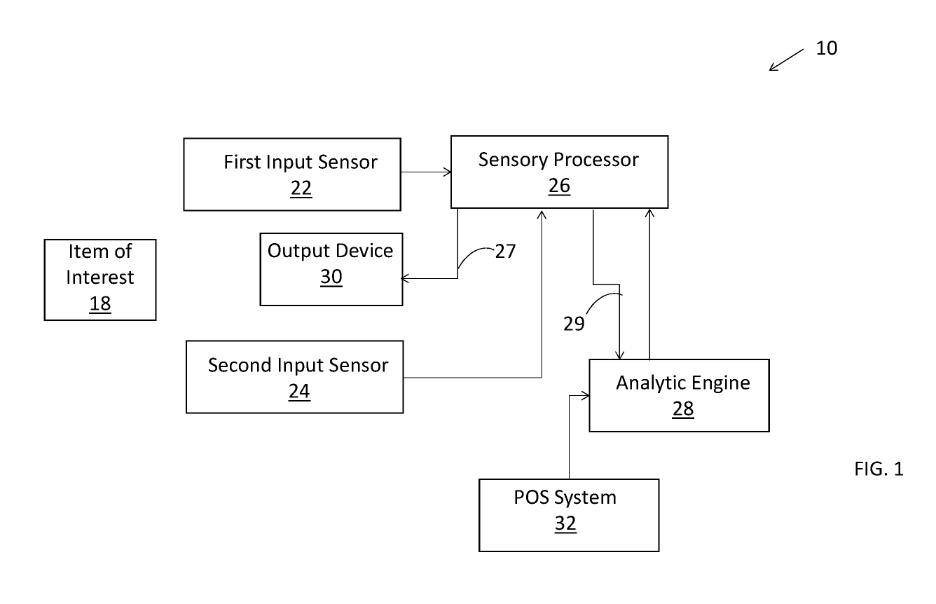

FIG. 1 is a block diagram of a sensory system 10, in accordance with some embodiments. The sensory system 10 includes at least one first input sensor 22, at least one second input sensor 24, a sensory processor 26, an analytic engine 28, and at least one output device 30. Some or all of these elements of the sensory system 10 may be part of a same hardware computer platform, or may be physically separate from each other, and in communication with each other via wired or wireless network interfaces.

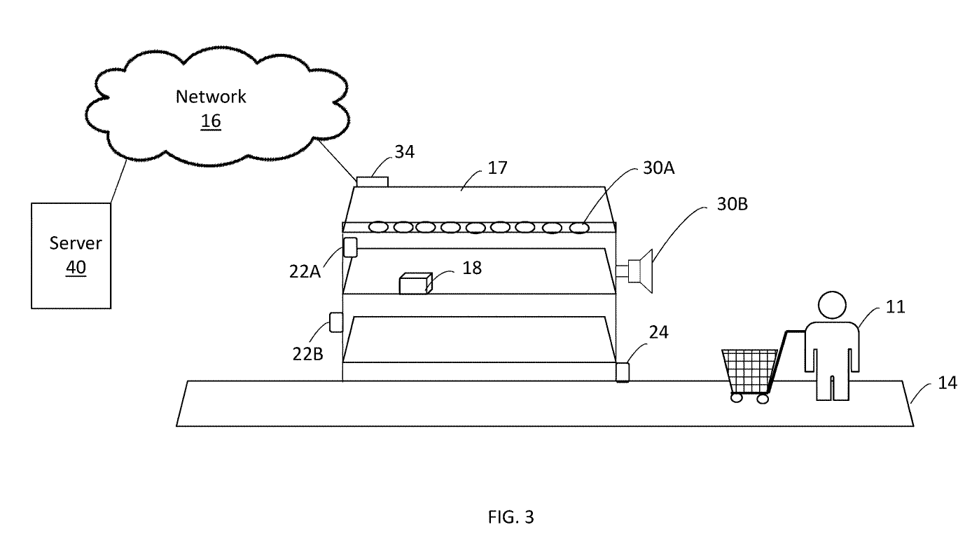

The first and second input sensors 22, 24 are positioned near product areas. The first input sensors 22 can detect sensory output from the output devices 30 and/or from the products at the product areas. For example, as shown in FIG. 3, an output device 30A may an LED device that emits light at a particular color, for example, yellow, which may be seen by a customer 11 at a baked goods aisle 14, and detected by an input sensor 22A, e.g., a color sensor. In the same example, shown in FIG. 3, another input sensor 22B may detect the smell of bread on a store shelf 17 in the baked goods aisle 14. Another input sensor (not shown) may detect the sound of running water, either generated from pre-recording and output from a speaker 30B, or from a man-made stream (not shown) at the baked goods aisle, or from another source the produces the sound of running water.

The second input sensor 24 can detect customer actions, such as foot motion, sales-related events, and/or other events for optimizing the output of the output devices 30. Referring to the previous example, the second input sensor 24 can include sonar, a light sensor, or video device for detecting foot traffic by customers at or around the baked goods aisle.

In sum, the first input sensor(s) 22 can detect sense-related information regarding an item of interest 18, and second input sensor(s) can detect result-related information in response to output device outputs. For, example, referring again to FIG. 3, motion sensor 24 may detect more foot traffic by store customers in response to the color yellow of LED light 30A sensed by sensor 22A combined with the smell of baking bread sensed by sensor 22B. Alternatively, sensor 24B may detect the presence of a customer by communicating with the shopper's smartphone, or an electronic emitter on the shopping cart, or other electronic communication establishing the shopper's proximity to store items 18. In related example, other sensors or processors can detect point of sale (POS) transactions for products for sale, e.g., bread, in the baked goods aisle 14 by determining that bread sales increased when the color yellow of LED light 30A is combined with the smell of baking bread.

The sensory processor 26 receives the data collected by the first and second input sensors 20, 24 and processes the received sensor data to determine actions that may be taken with the one or more output devices 30. The sensory processor 26 may combine the sensor data with analytic data provided by the analytic engine 28 to generate a modification signal that is used to control or adjust the one or more output devices 30. The analytic engine 28 receives and processes data, for example, sales transaction data from a POS system 32, which can be used to determine the effectiveness of the output of the one or more output devices 30. Referring again to the example illustrated at FIG. 3, the analytic engine 28 can determine that the color yellow emitted from LED 30A results in additional bread sales. This data can be processed by the analytic engine 28 and output to the sensory processor 26, which generates a modification signal 27 to change the color of the LED 30 to yellow when the motion sensor 24 detects foot traffic by customers 11 in the bread aisle 14.

The sensory processor 26 can also generate an output 29 to the analytic engine 28 that includes sensory changes made to the output device 30. In particular, when a sensor change is made, the sensory processor 26 generates an output 29 to the analytic engine 28, which can correlate the sensor change data with data from the POS system 32 and/or other system that generates financial, marketing, or other data regarding the item of interest 18. The analytic engine 28 can use this new information to compare with subsequent sales data from the POS system 32 and generate an output to the sensory processor 26 that may use the comparison result to provide subsequent changes 29 to the output devices 30. Therefore, a connector between the sensory processor 26, the analytic engine 28, and the POS system 32 forms a feedback loop. Feedback data may include but not be limited to rate of sale, inventory levels, promotional indicators, or customer/social responses.

The system can be configured for a value corresponding to a desired goal or objective. For example, a store may desire to increase the sale of bread. In doing so, an output device 30 may include an olfactory device that emits the smell of bread based on analytics establishing that customer sales of bread increase when the olfactory device 30 emits the smell of bread. The system “learns” that this behavior results in increased customer attention toward a particular item 18.

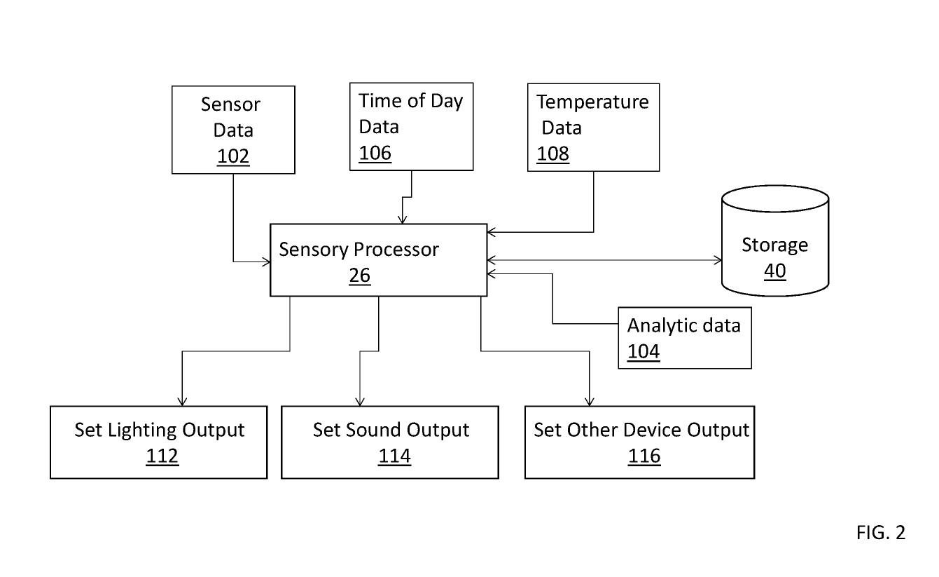

FIG. 2 is a data flow diagram illustrating data exchanges with elements of a sensory system 26, in accordance with some embodiments. In describing FIG. 2, reference is made to elements of FIG. 1 and/or examples illustrated in FIG. 3.

Sensory processor 26 can receive sensor data 102 and environmental data such as time of day 106 and temperature data 108. Sensor data 102 can be provided by input sensors 22, 24, for example, motion, light, sound and so on. Environmental data 106, 108 may also be provided to sensory processor to establish conditions related to the modification of output devices 30. For example, color LED 30A may be changed to yellow during late afternoon hours based on historical data (stored at storage device 40) indicating that store customers tend to purchase bread during this time of day.

Analytic data 104 may be generated at analytic engine 28, and may indicate an effectiveness of the output from sensory processor 26, and be provided to the output setting components of the sensory processor 26, for setting lighting output 112, sound output 114, and/or other output device outputs.

FIG. 3 illustrates an example of a retail environment, in accordance with some embodiments. As described above, retail environment may include a location where items 18 are positioned, and located for purchase by customers 11. The retail environment may include sensors 22, 24, a microcontroller 34, a server 40, and/or mobile electronic device (not shown) with the user 11 that communicate with each other and/or other electronic devices via a network 16, which may include a local area network (LAN), WiFi network, wide area network (WAN), and/or other communication network. In some instances, elements of the retail environment may be directly connected to each other, for example, programmable light strip 30A and speaker 30B directly connected to microcontroller 34.

Microcontroller 34 may match input sensor data with actions it should take with output devices 30A, 30B, such as programmable lighting, speakers, olfactory output devices, and so on. Microcontroller 34 may include the sensory processor 26. For example, sensor 22A may determine that item 18 is colored green and send this information to the microcontroller 34, which may in turn set the lights 30A to be a complementary color, e.g., yellow. In another example, speaker 30B may receive a signal from the microcontroller 34 to emit ambient noise that is pleasant to the ear of the customer 11, which may result in the customer purchasing item 18.

The server 40 may include the analytic engine 28, which may be onsite or at a remote location. The server 40 may perform analytic analysis to determine appropriate output device setting, which may be optimized for sales, foot traffic, customer interest, and so on, based on previous data regarding interaction with the item 18.

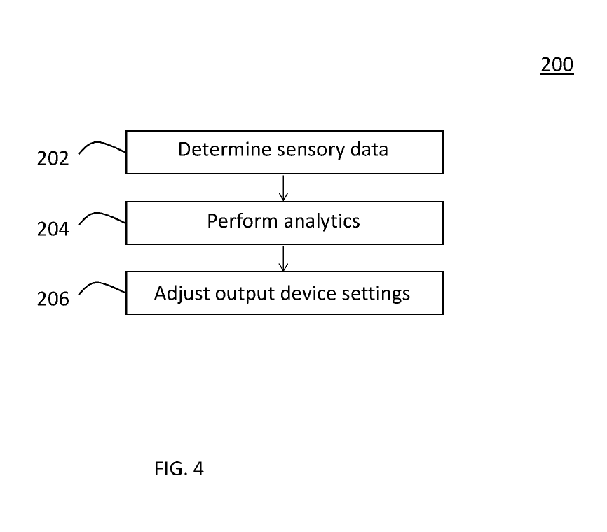

FIG. 4 is a flow diagram of a method for setting a sensory output, in accordance with some embodiments. In describing FIG. 4, reference is made to elements of FIGS. 1-3.

At block 202, a shopper 11 arrives at a store aisle 14, and more specifically, to a store shelf 17 at the aisle 14. Here, one or more second sensors 24 may detect customer actions at or near the store shelf 17, for example, detect the presence of the shopper 11, detect a smell of cologne on the shopper 11, detect via video the shopper 11 picking up other items on the shelf 17 or other locations along the aisle 14, and/or other sensory data related to actions taken by the shopper 11. The first sensors 22 may detect sensory information regarding the item 18 or regarding events occurring near the item 18, for example, the smell of bread, the color of the item 18, and so on.

At block 204, analytics are performed based on collected data such as sales, inventory, advertisement and promotion, historical data such as previous customer purchases, and/or any other data related to the store, item, shopper, and/or social environment.

At block 206, settings of one or more output devices 30 are adjusted based on a generated result of the analytics performed at block 204. The output devices 30 perform functions that may affect customer behavior. For example, an LED may emit a color that results in the shopper staying longer at the store. This data, i.e., the amount of time that the customer stays at the store after the LED emits the color, can be stored at storage device 40, and used by the analytic engine 28 to perform analytics, the result of which is output to the sensory processor 26. Multiple sensors, for example, light, motion, sound, temperature, and so on can provide data that is combined with analytics results to change multiple output types, e.g., LEDs, sound output, olfactory output, and so on, in an optimal manner based on a desired goal, for example, to increase sales, foot traffic, and so on

As will be appreciated by one skilled in the art, concepts may be embodied as a device, system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Computer program code for carrying out operations for the concepts may be written in any combination of one or more programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

What is claimed is:

1. A sensory system, comprising:
at least one input sensor proximal an item for sale at a retail establishment, the sensor collecting data related to the item for sale, and the sensor generating a sensor signal;
an analytic engine that performs analytics and generates an analytic signal;
a sensory processor that generates an output device modification signal that is modified in response to the analytic signal and the sensor signal; and
an output device that generates the sensory output according to the output device modification signal.

2. The sensory system of claim 1, wherein the at least one input sensor includes a first input sensor and a second input sensor that collectively measure customer interaction.

3. The sensory system of claim 1, wherein the data related to the item for sale includes shopping behavior information.

4. The sensory system of claim 1, wherein the at least one input sensor includes sonar, light sensors, olfactory sensor, color sensor, or motion sensor.

5. The sensory system of claim 1, wherein the sensory processor matches the input sensor data with actions it should take with respect to the output device.

6. The sensory system of claim 1, further comprising a device that determines a strategy that is implemented based on the characteristic of the output device.

7. The sensory system of claim 1, further comprising a connector between the analytic engine and the sensory processor for providing feedback.

8. The sensory system of claim 7, wherein the feedback includes rate of sale, inventory level, promotional indicator, or customer or social responses.

9. The sensory system of claim 7, wherein the analytics involves combining inputs, and setting outputs correlated with a feedback signal to be optimized.

10. A method for dynamic multi-sensory environmental control, comprising:
collecting data related to an item for sale;
generating a sensor signal from the collected data;
performing analytics and generating an analytic signal;
generating an output device modification signal that is modified in response to the analytic signal and the sensor signal; and
outputting the sensory output according to the output device modification signal.

11. The method of claim 10, further comprising determining a strategy that is implemented based on the characteristic of the output device.

12. The method of claim 10, further comprising providing a connector between the output device and the sensory processor for providing feedback.

13. The method of claim 12, wherein the analytics involves combining inputs, and setting outputs correlated with a feedback signal to be optimized.

14. The method of claim 10, wherein the sensor signal is generated by at least one of sonar, light sensors, olfactory sensor, color sensor, or motion sensor.

15. A method for setting a sensory output, comprising:
determining sensory data regarding a store item of interest and events occurring near the item;
performing analytics to determine an effectiveness of a sensory output of an output device; and
adjusting the sensory output of the output device in response to performing the analytics.

16. The method of claim 15, wherein the sensor data is generated by a combination of sonar, a light sensor, an olfactory sensor, a color sensor, and a motion sensor.
